(19) United States
(12) Patent Application Publication
(10) Pub. No.: US 2022/0197603 A1
(43) Pub. Date: Jun. 23, 2022

(54) METHODS AND SYSTEMS FOR DESIGNING, WRITING, AND TESTING ZERO-KNOWLEDGE PROOFS

(71) Applicant: Aleo Systems Inc., San Francisco, CA (US)

(72) Inventors: Howard WU, Union City, CA (US); Collin CHIN, San Francisco, CA (US); Raymond CHU, Arcadia, CA (US)

(73) Assignee: Aleo Systems Inc., San Francisco, CA (US)

(21) Appl. No.: 17/461,700

(22) Filed: Aug. 30, 2021

Related U.S. Application Data
(60) Provisional application No. 63/071,674, filed on Aug. 28, 2020.

(51) Int. Cl. G06F 8/33; G06F 8/41; H04L 9/32; G06F 11/36

(52) U.S. Cl. CPC G06F 8/33; G06F 11/3664; H04L 9/3218; G06F 8/41

(57) ABSTRACT

There are provided systems and methods for providing tools in an integrated development environment (IDE) for performing one or more of defining, compiling, packaging, collaborating, and testing zero-knowledge proofs.

### I. TECHNICAL FIELD

The present invention relates generally to software. In particular, the present invention relates to software systems for verifying zero-knowledge proofs used in cryptography.

### II. BACKGROUND

In the field of cryptography, as understood by one of skill in the art, a zero-knowledge proof (ZKP) is a digital protocol, or digital authentication process, that facilitates sharing of data between parties without passwords. Conventional ZKP systems do not possess an ability for developers to easily specify, design, write, and/or test the logic or code that defines a ZKP. Such systems would improve the speed and accuracy of the underlying encryption. For example, testing methodologies that are currently available to users are typically low level and are not integrated together.

Additionally, conventional systems do not provide an ability at all to test a ZKP outside of writing a formal proof about its correctness. Implementing a conventional technique to test the correctness of a ZKP, such as writing out in longhand with the mathematical proof can be laborious and require specific skill sets. Accordingly, use of these conventional systems is largely impractical.

### III. SUMMARY

The embodiments featured herein help solve or mitigate the above noted deficiencies as well as other issues known in the art. For example, what is needed are methods and systems that provide the ability to specify, design, write, and test the logic or code that defines a ZKP. Embodiments of the present invention offers tools that provide this ability and an integrated environment. Additionally, methods and systems constructed in accordance with the embodiments, provide the ability to specify, design, write, and test ZKPs faster and more accurately, with a requirement of less detailed expertise. More specifically, the embodiments provide an integrated development environment (IDE) for specifying, designing, writing, and testing ZKPs.

Under certain circumstances, an embodiment of the present invention provides systems and methods for providing tools in an IDE for performing one or more of defining, compiling, packaging, collaborating, and testing zero-knowledge proofs.

Additional features, modes of operations, advantages, and other aspects of various embodiments are described below with reference to the accompanying drawings. It is noted that the present invention is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### IV. BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an exemplary sign-up in accordance with the embodiments.

FIG. 2 illustrates an exemplary new screen under integrated development environment (IDE) concepts in accordance with the embodiments.

FIG. 3 illustrates an exemplary cashing of IDE cryptographic credentials.

FIG. 4 illustrates an exemplary authentication process.

FIG. 5 is an illustration of exemplary start of a ZKP application.

FIG. 6 is a block diagram illustration of an exemplary skeleton of a ZKP.

FIG. 7 is an exemplary screenshot of ZKP application.

FIG. 8 illustrates an exemplary custom template in accordance with the embodiments.

FIG. 9 illustrates exemplary typing actions functionalities.

FIG. 10 illustrates detection and parsing of code.

FIG. 11 illustrates exemplary improved readability.

FIG. 12 illustrates exemplary IDE logic detection.

FIG. 13 illustrates exemplary IDE suggestion functionality.

FIG. 14 illustrates an exemplary IDE notification process.

FIG. 15 illustrates exemplary compilation of remote deployment.

FIG. 16 illustrates exemplary ZKP transaction deployment.

FIG. 17 illustrates an exemplary one-click button for deployment.

FIG. 18 illustrates an exemplary on-chain transaction submission process.

FIG. 19 illustrates an exemplary IDE simple user face.

FIG. 20 illustrates exemplary native integration with package manager and a block chain.

FIG. 21 illustrates an exemplary cryptographic data importation process.

FIG. 22 illustrates an exemplary updating of user profile settings.

FIG. 23 illustrates an exemplary user locate and remote code features functionality.

FIG. 24 illustrates an exemplary visualizer 40 knowledge circuits.

FIG. 25 illustrates an exemplary rendering engine for user interface (UI) display.

FIG. 26 illustrates an exemplary screenshot of domain reasoning.

FIG. 27 illustrates exemplary UI rendering.

FIG. 28 illustrates exemplary console output responsive to ZKP application.

FIG. 29 illustrates an exemplary IDE search functionality.

FIG. 30 illustrates an exemplary window of a normal search.

FIG. 31 illustrates an exemplary remote search function.

### V. DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

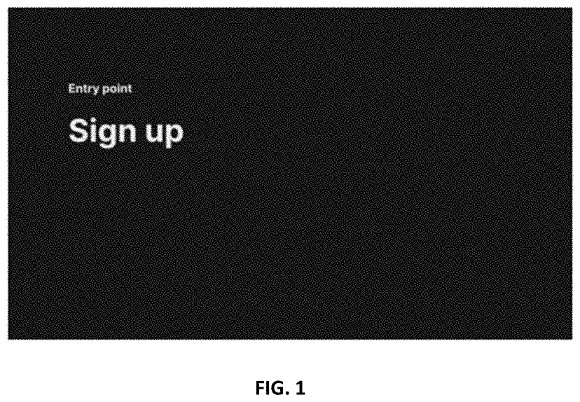

FIG. 1 illustrates an exemplary sign-up in accordance with the embodiments. This is one of the initial entry points when opening the IDE. The IDE provides a streamlined process for the user to create an account, performing cryptographic setup under the hood for the user.

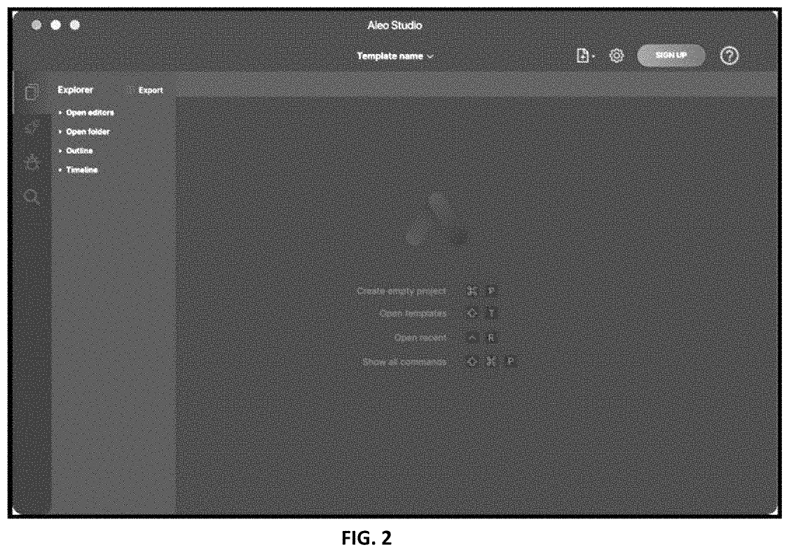

FIG. 2 illustrates an exemplary new screen under IDE concepts in accordance with the embodiments. In FIG. 2, a new user is presented with an initial empty screen on first open. Under the hood, the IDE is checking whether a cryptographic credential is stored on-device. If so, it will begin to sync state with the public blockchain to scan for new state relevant for an application runtime environment in the IDE. If there is no cryptographic credential stored on-device, then the IDE will present the user with the option to Sign Up or Sign In.

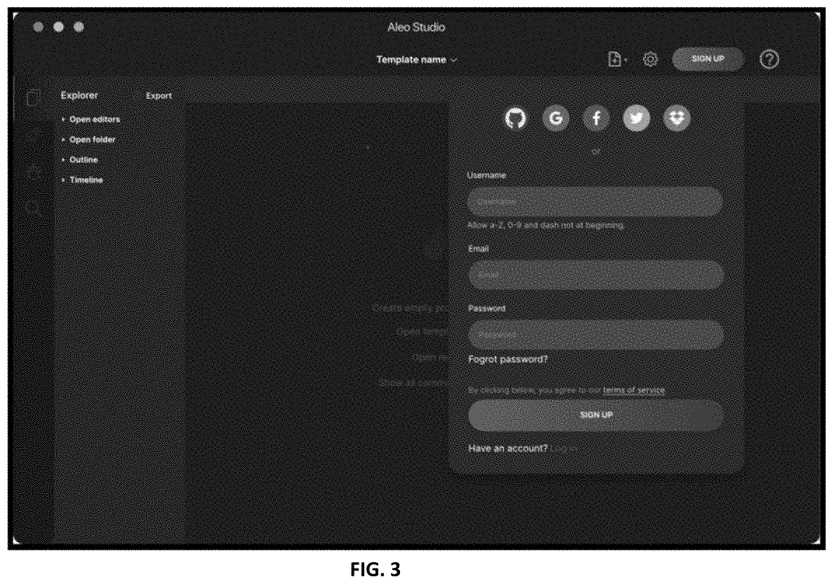

FIG. 3 illustrates an exemplary cashing of IDE cryptographic credentials. The new user clicks on Sign Up to create an account, if they do not have an account already. Under the hood, IDE caches a cryptographic credential used to authenticate queries for remote features between IDE, servers, and zero-knowledge provers. This cryptographic credential is able to authenticate the construction of zero-knowledge proofs that will verify on the blockchain. For example, by deriving a Schnorr private key, the client can sign a transaction kernel for broadcast on a public blockchain.

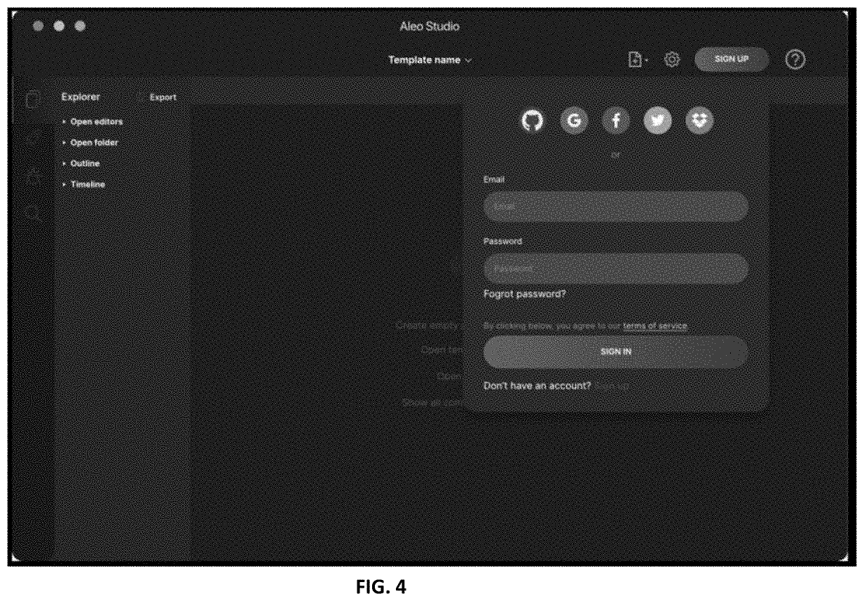

FIG. 4 illustrates an exemplary authentication process. In FIG. 4, if the new user has an account already, they can click to Sign In instead. Under the hood, IDE caches a cryptographic credential used to authenticate queries for remote features between IDE, servers, and zero-knowledge provers. This cryptographic credential is able to authenticate the construction of zero-knowledge proofs that will verify on the blockchain.

This cryptographic credential is able to authenticate the construction of zero-knowledge proofs that will verify on the blockchain. For example, by deriving a Schnorr private key, the client can sign a transaction kernel for broadcast on a public blockchain.

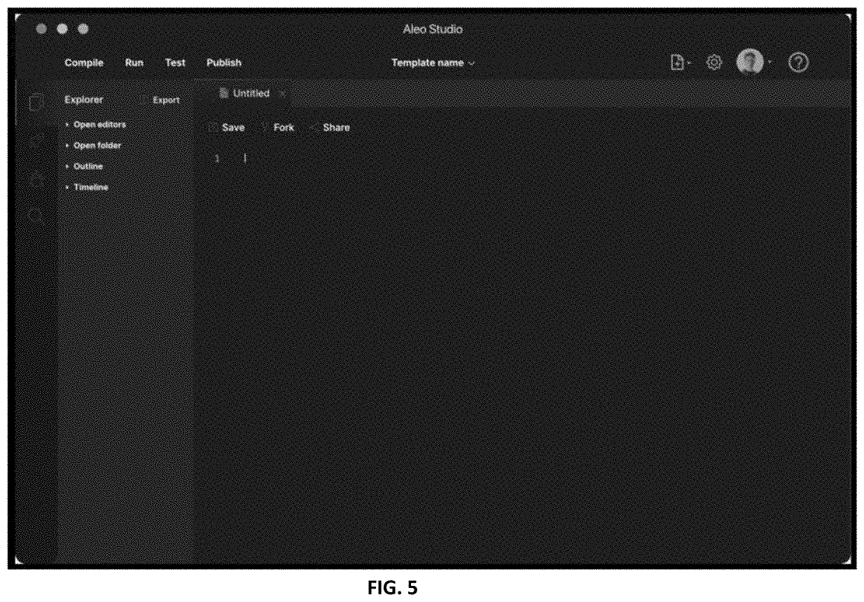

FIG. 5 is an illustration of exemplary start of a ZKP application. As illustrated in FIG. 5, once signed in, the IDE now has a cryptographic credential of the user stored and the user can start writing a zero-knowledge application. When writing applications, the cryptographic credential will be referenced for fetching the user's existing or past transaction state on the blockchain, to simulate and execute the zero-knowledge application's runtime environment.

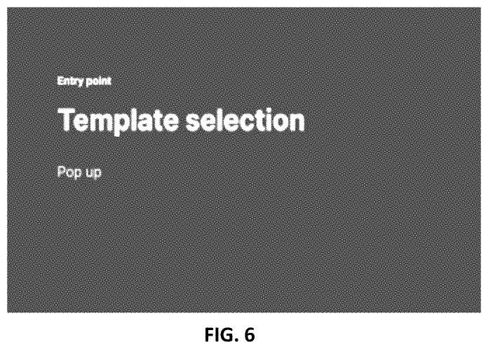

FIG. 6 is a block diagram illustration of an exemplary skeleton of a ZKP application. The user is given a selection of templates which can be used to initialize a skeleton of a zero-knowledge application. These templates include ones provided by the IDE, ones from a predefined package manager, and ones from the user's private template repository, which can be from teams or organizations in the predefined package manager or similar hosted services.

For templates that have dependencies of their own, the IDE is able to fetch these from the predefined package manager or from an on-chain circuit registry, which verifies and stores the circuit, proving key, and verification key. The IDE can use this to reconstruct the local keys and hash them to confirm its equivalence to what is stored on-chain.

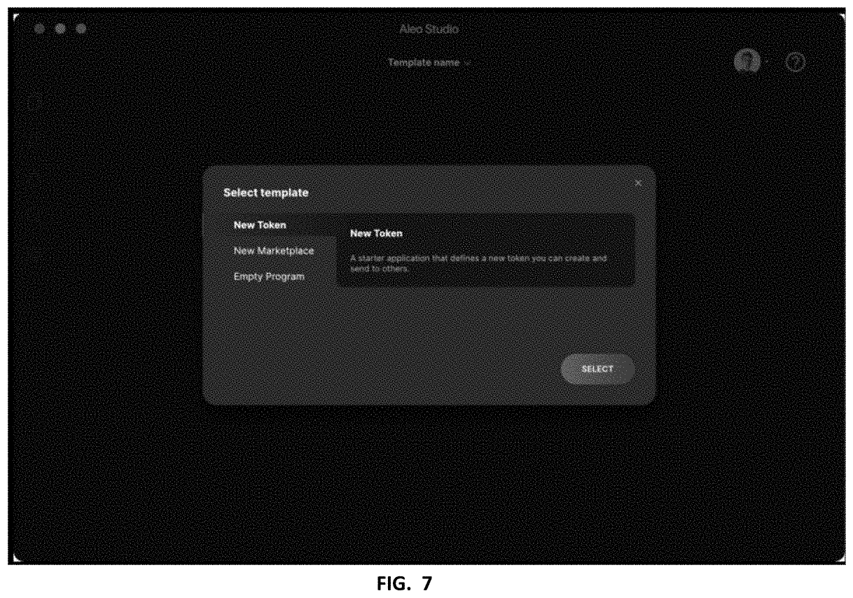

FIG. 7 is an exemplary screenshot of ZKP application. In FIG. 7, there are examples of some zero-knowledge applications. Under the hood, the IDE will fetch community-driven templates from the package manager, or from the user's private account. If they are part of a team or organization with private templates, these will be remotely fetched as an option. When fetching templates, the cryptographic proving key and verification key of a program will be provided if relevant and hashed to compare against the registry.

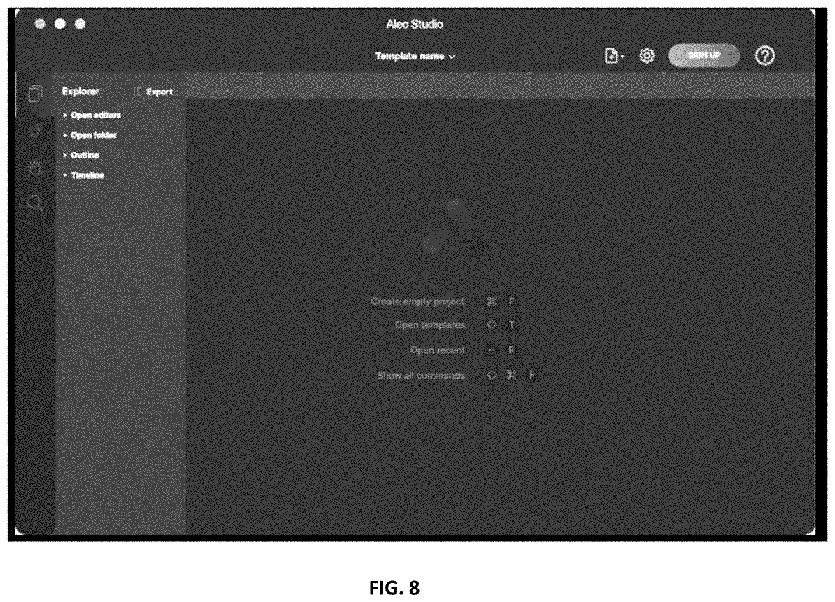

FIG. 8 illustrates an exemplary custom template in accordance with the embodiments.

Users can also create their own custom templates to support new use cases, or industry-specific applications that require zero-knowledge proofs—whether it be for confidentiality, integrity, efficiency, or scalability.

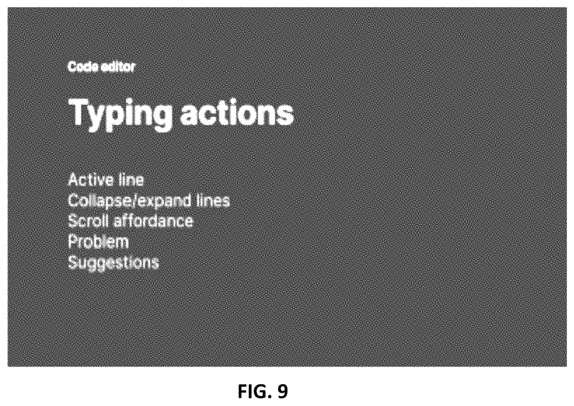

FIG. 9 illustrates exemplary typing actions functionalities. Typing actions provide convenient user functionalities for interactions in the IDE. Some functionalities listed are able to be processed client-side, while others require remote processing to work performantly or at all.

In many instances, when the zero-knowledge application is large, the client's machine is unable to process the typing action locally and requires assistance from a remote server and remote prover to facilitate real-time interaction.

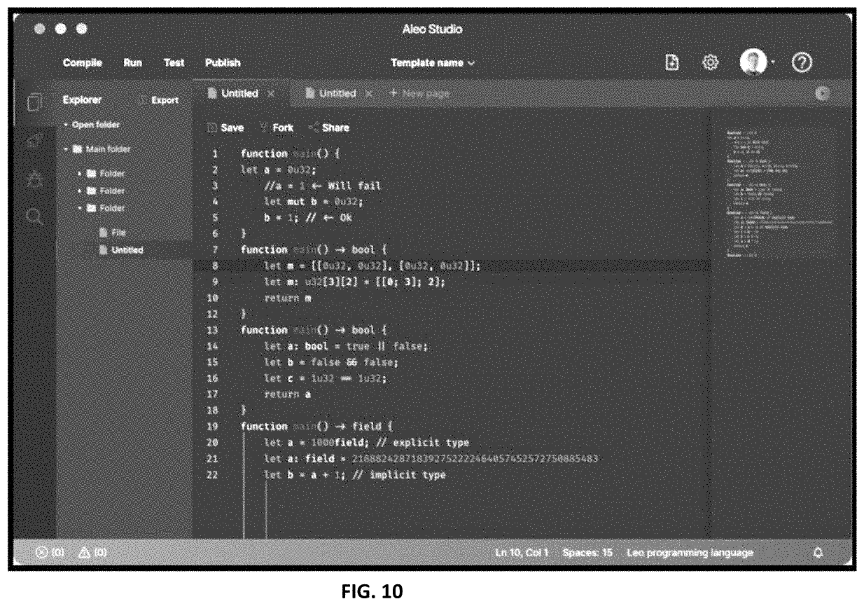

FIG. 10 illustrates detection and parsing of code. In FIG. 10, detection and parsing of every line of code is provided, and check in real-time that the logic adheres to protocol syntax.

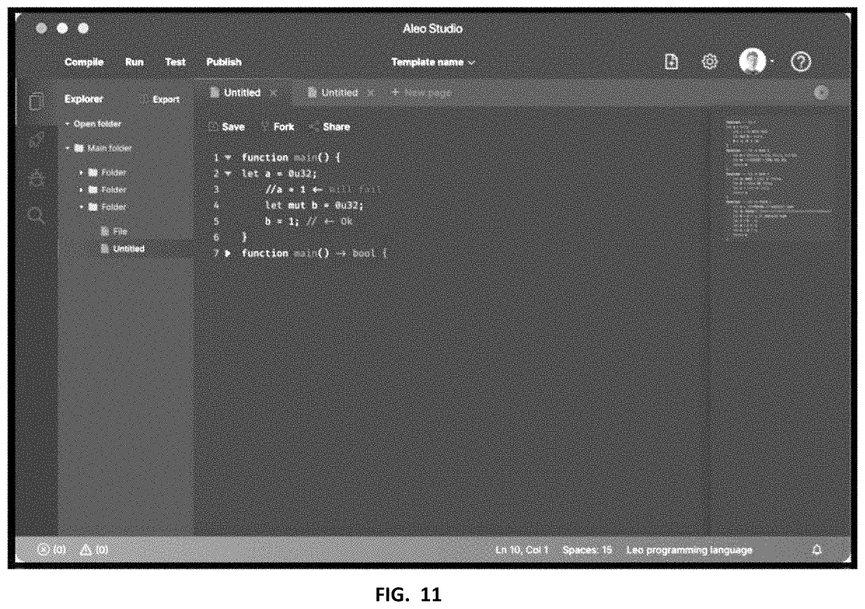

FIG. 11 illustrates exemplary improved readability. In FIG. 11, to improve readability, functions can be folded so as to make it easier to parse large files.

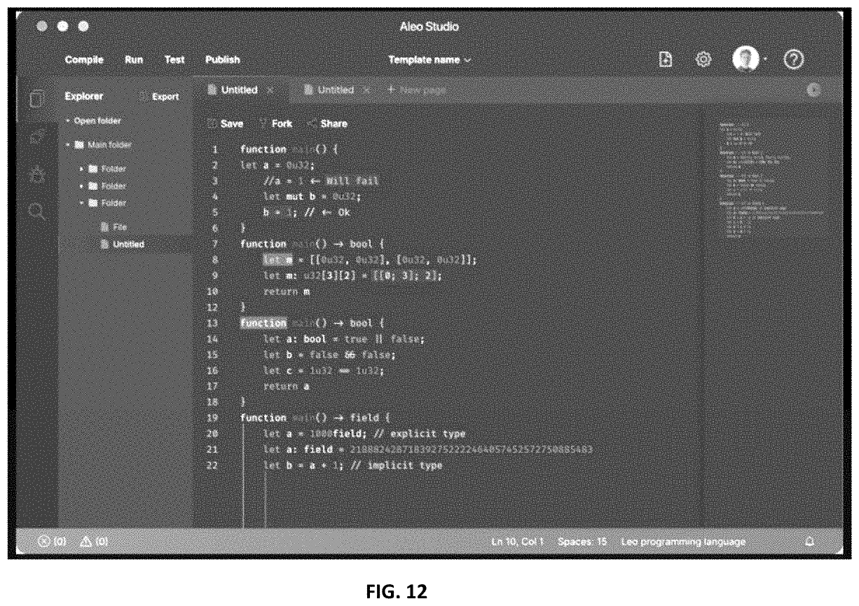

FIG. 12 illustrates exemplary IDE logic detection. In the illustration of FIG. 12, the IDE is able to detect when logic is incorrect or could result in problematic execution—such as the Halting Problem. When non-determinism is introduced in a zero-knowledge circuit, it will result in irreproducible outputs. To prevent this, the IDE simulates circuit synthesis in real-time to check for impossibility conditions and immediately alerts the user to detected flaws in logic.

To ensure this operation runs performantly, the IDE first performs a syntactic check on the language, which itself is designed as the first layer of defense. By ensuring the language minimizes the opportunity for impossibility scenarios, the IDE is able to quickly parse on a high-level for obvious mistakes.

Next, to ensure the written logic corresponds safely for performing synthesis checks, the IDE will attempt to perform parsing to generate an abstract syntax tree (AST). The AST itself includes intermediate representations for imported dependencies or user-provided inputs in the ‘inputs’ directory. This AST is then interpreted in real-time into the IDE's type system which allows for partial compilation, to check just one subset or even one step of compilation of the zero-knowledge application.

Then, once the type system resolution is successful, the IDE will attempt to perform checks on a generated circuit or partial circuit. To ensure the logic is deterministic and bounded, the IDE will attempt circuit synthesis of the logic block and check for cyclic dependencies in the circuit wires. In addition, it will check for obvious mistakes in circuit wires—e.g. reference to non-existent public or private assignment variables in the circuit. If problem detection fails at any point in this pipeline, the IDE will inform the user of the problematic logic and provide suggestions for what to write instead, which we discuss next.

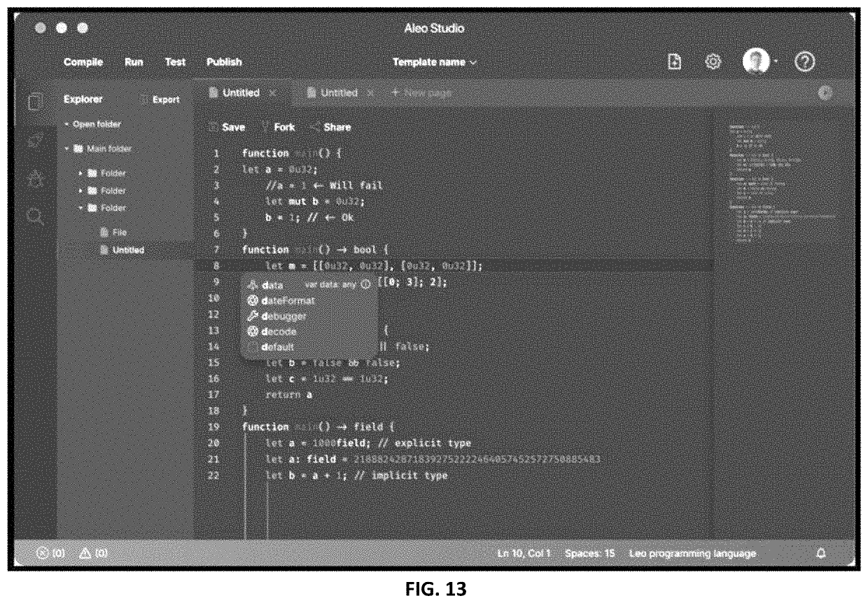

FIG. 13 illustrates exemplary IDE suggestion functionality. As shown in FIG. 13, to simplify the user's development journey, the IDE also provides suggestions. As the application is a zero-knowledge circuit, the IDE is able to identify sub-circuits, or gadgets, and construct smart suggestions by suggesting matching types from one gadget's output type to another gadget's input type.

When a user needs to provide a function signature or function input, the IDE is able to detect based on used wires, which output wires are relevant to the gadget the user is writing by leveraging its internal type system to identify relevant options. Unlike a normal IDE, which will suggest relevant inputs purely based on matching signature or syntax, this IDE for zero-knowledge applications can suggest better options as it semantically tracks the circuit and its progression/change.

Therefore, if a specific input, which syntactically looks like it matches, is technically an illegal operation, the IDE, because of its circuit synthesis subroutine, is able to detect this and prevent the user from writing such logic. This results in an application writing experience that is specialized for zero-knowledge applications and minimizes writing illegal logic by the user.

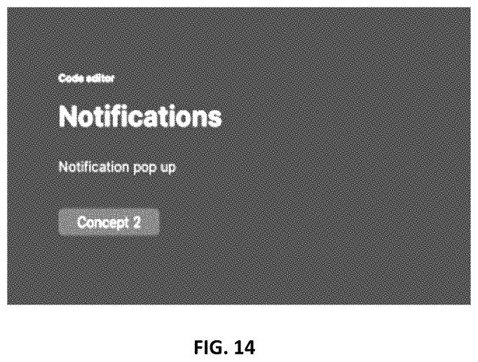

FIG. 14 illustrates an exemplary IDE notification process. A notification system is introduced into the IDE for asynchronous communication between the user, and servers or provers. The intention of this feature is to allow for seamless state management by the IDE for various operations.

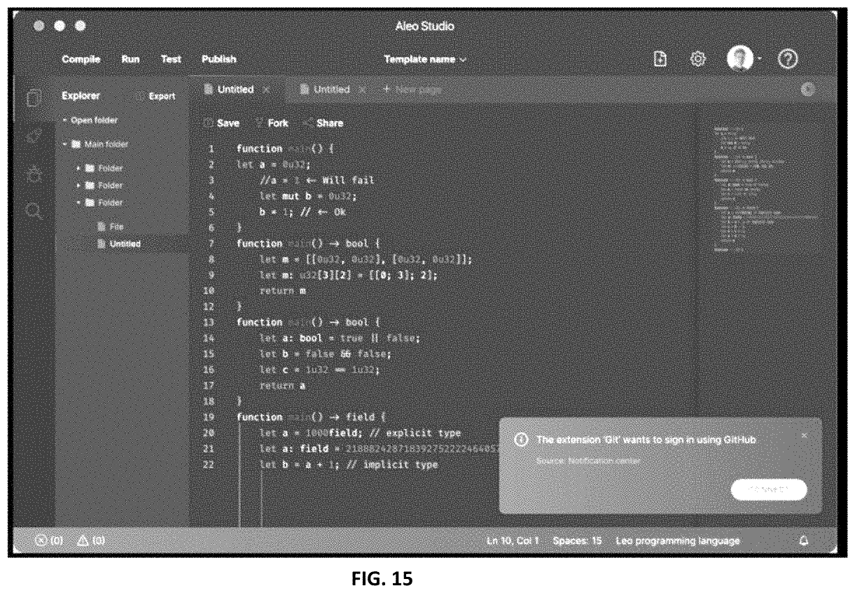

FIG. 15 illustrates exemplary compilation of remote deployment. When the user sends a request for remote compilation or remote deployment, this operation can be managed in the background by the IDE. Since proving key and verification key generation can take up to hours for large applications, these cryptographic operations are best performed on a remote server. Therefore, to allow the user to continue writing code, the IDE will perform signing of the request with the user's cryptographic credential, send this request to a remote compiler, and track state of the request in its own system.

When the request is completed, the IDE will fetch the state and notify users of the task completion. Then the user is provided with a remote view of the result. If the user wishes to download the proving key and/or verification key, the notification becomes the entry point to request and fetch this data with their cryptographic credential.

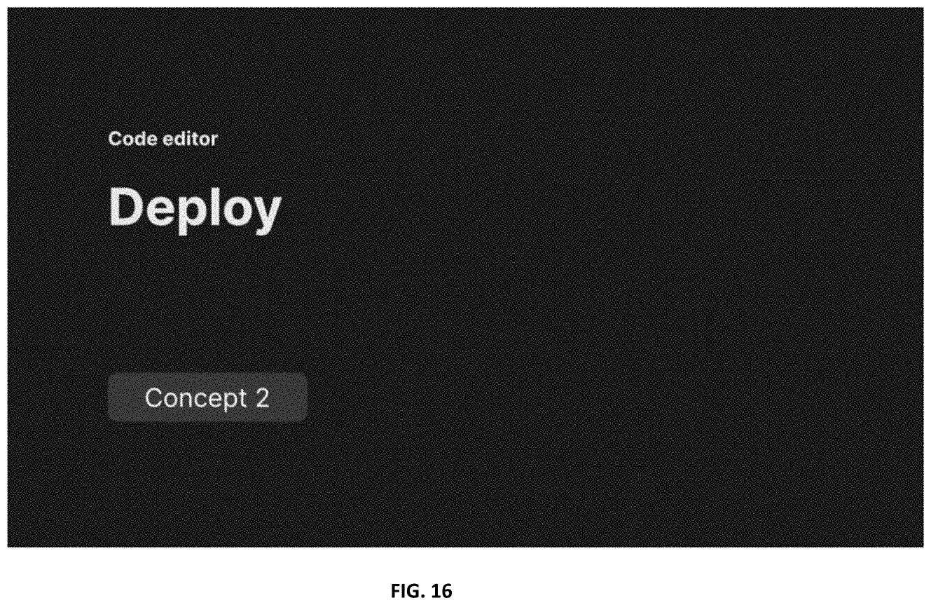

FIG. 16 illustrates exemplary zero-knowledge transaction deployment. When the user has finished writing their application, the IDE is able to use the user's cryptographic credential to sign the zero-knowledge application, generate proving key and verification key, and proceed to craft a valid zero-knowledge transaction to deploy the circuit to the on-chain registry.

This seamless integration allows the IDE to semantically check that the circuit is synthesized correctly, that it is a valid state transition, and that it has cryptographic permission on behalf of the user to deploy the application.

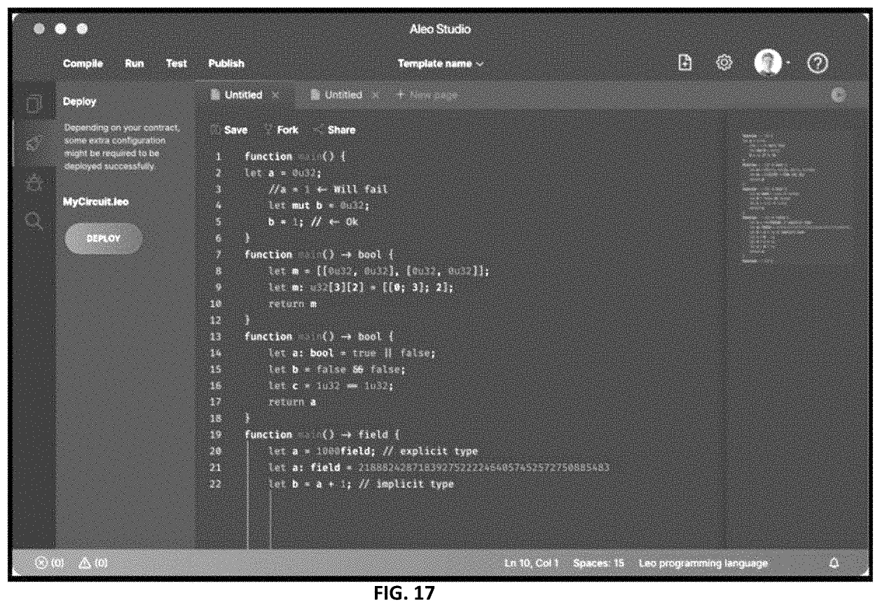

FIG. 17 illustrates an exemplary one-click button for deployment. To make this process simple for the user, the IDE provides a one-click button to deploy, which allows the IDE to take over the application, begin compiling and running it to ensure its validity, and proceed to bundle and package it into a zero-knowledge circuit for deployment. Once the transaction is broadcast, the IDE will continue monitoring the blockchain for status and push a notification to the user if the deployment succeeded or failed.

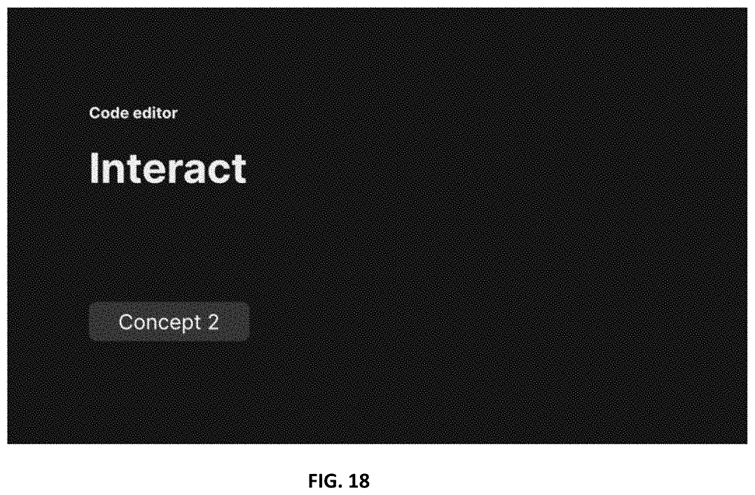

FIG. 18 illustrates an exemplary on-chain transaction submission process. In FIG. 18, once a zero-knowledge application is deployed, the user is able to interact with the application on-chain by submitting transaction requests to the IDE. The IDE will fetch the necessary state and dependencies with the user's cryptographic credentials. Additionally, it will sanitize the user's interaction inputs to ensure it is valid to the type system and application parameters. The IDE will allow the user to choose to generate a transaction locally or through remote execution, which is useful for programs that are large and therefore unable to run on the user's machine.

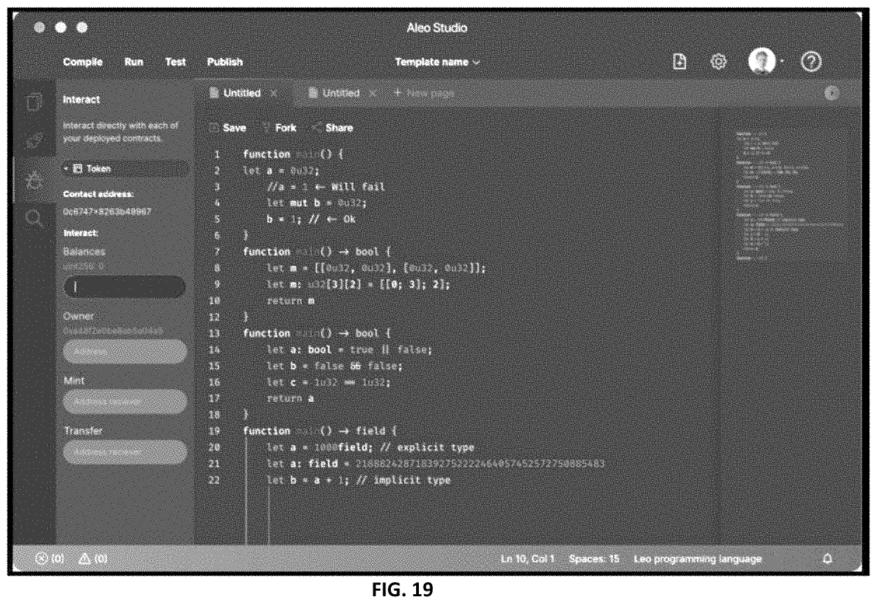

FIG. 19 illustrates an exemplary IDE simple user face. To interact, the IDE provides a simple user interface which parses the zero-knowledge application's methods, converts them to form input fields, and proceeds to do the same syntactic checks, type resolution, and circuit synthesis as the problem detection functionality. These checks ensure the user's interactions satisfy the zero-knowledge circuit and save the user time and compute resources.

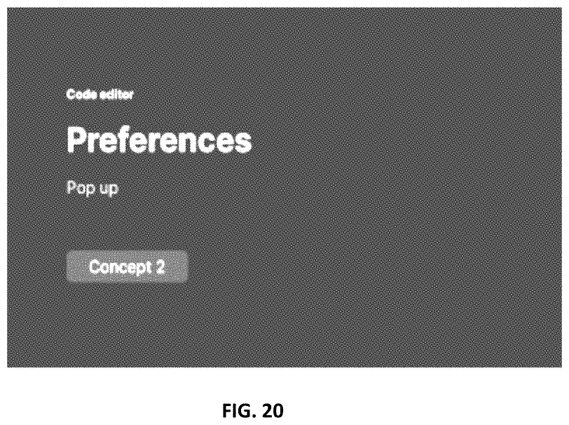

FIG. 20 illustrates an exemplary native integration with package manager and a block chain. The IDE provides native integration with a community-driven package manager and blockchain to make zero-knowledge application development a seamless experience.

To facilitate these integrations and features, the IDE has preferences to allow the user to control and define the level of deep integration they would like.

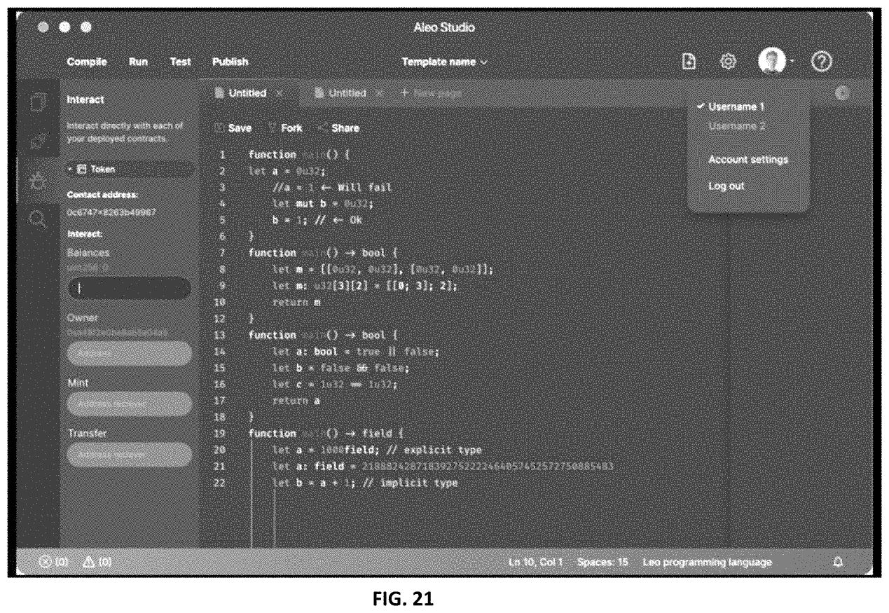

FIG. 21 illustrates an exemplary cryptographic data importation process. Users are able to import their cryptographic data, keys, templates, packages, and blockchain state into the IDE for direct access and use in zero-knowledge applications. In addition, they are able to create teams and organizations for collaborative features in developing a zero-knowledge application.

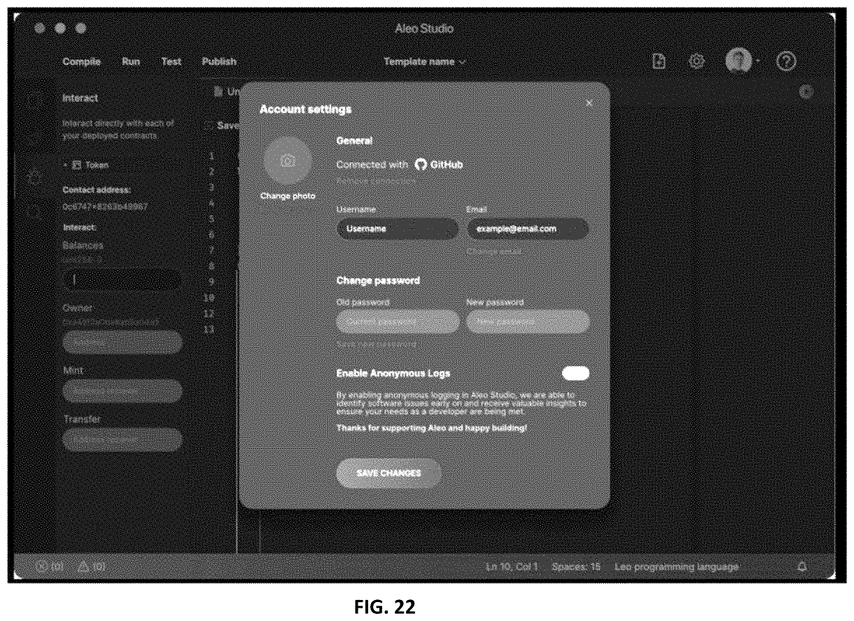

FIG. 22 illustrates an exemplary updating of user profile settings. The illustration of FIG. 22, the user is able to update their profile settings, and enable/disable certain profile features, such as anonymous logging.

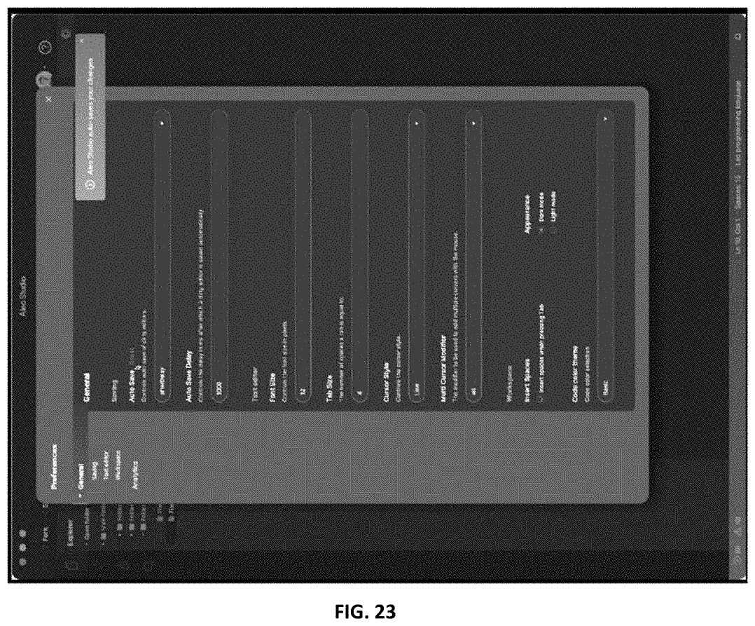

FIG. 23 illustrates an exemplary user locate and remote code features functionality. Here, the IDE provides user preferences for the user to enable local and remote code features. For example, they are able to enable remote compilation or turn it off. They can also sync their remote packages and state with the local IDE. These features are integrated with the user's cryptographic credential to allow for direct billing on the blockchain, and immediate circuit or state updates to the blockchain.

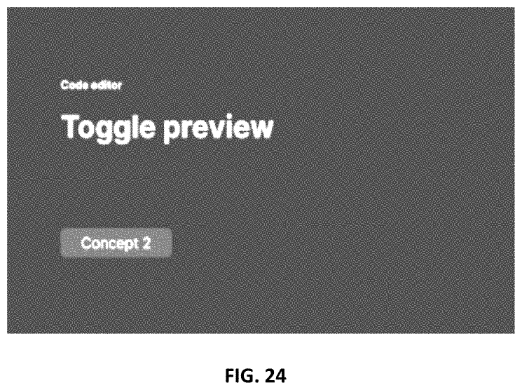

FIG. 24 illustrates an exemplary visualizer 40 knowledge circuits. The IDE provides the first known visualizer for zero-knowledge circuits. Unlike existing IDEs which are designed as executables, this IDE constructs arithmetic and Boolean circuits, which have a unique representation that can be visualized in graph form. In addition, the IDE is able to simulate the circuit, along with the programming language to generate a UI that normal end-users can interact with.

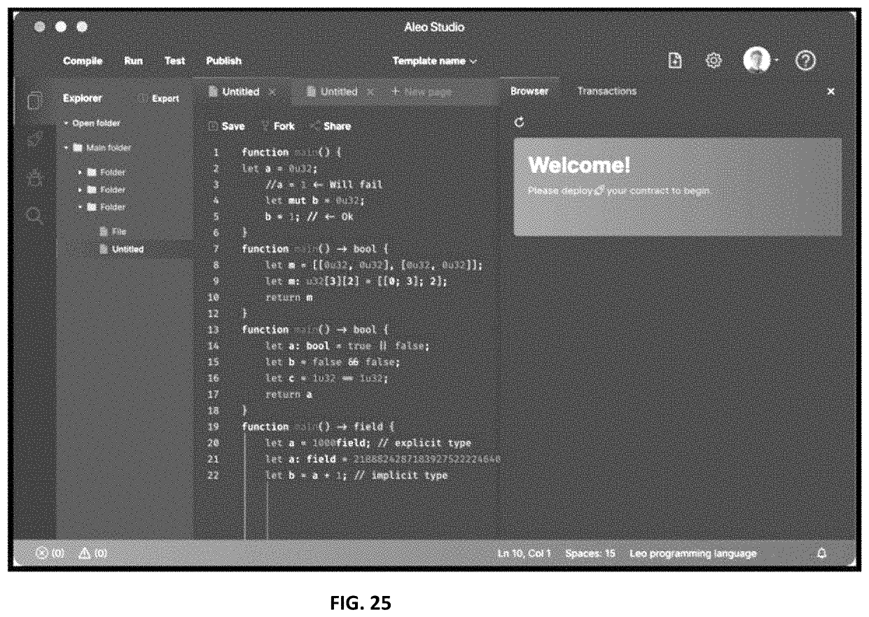

FIG. 25 illustrates an exemplary rendering engine for UI display. To allow for normal users to interact with a zero-knowledge application, the IDE provides a rendering engine for displaying the UI of a user-defined application. This UI incorporates circuit visualization and user-defined stories to create an application experience similar to normal apps. It does it by constructing a markdown language view and passes it to a custom rendering engine.

The engine interprets the inputs and constructs UI components that link the circuit functions to the components. These components are then displayed in a browser in the IDE, which allows the developer to immediately test the application they are writing in real-time.

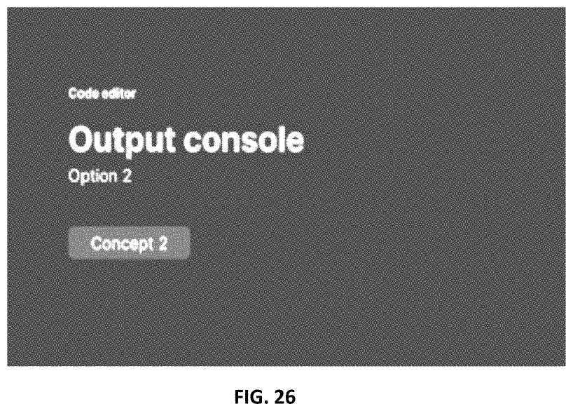

FIG. 26 illustrates an exemplary screenshot of domain reasoning. In addition, similar to web programming languages like Javascript, zero-knowledge applications require reasoning about two domains. In the Javascript case, the user writing the application must reason about both the local console (where error and logging messages are printed), but also the DOM (where the browser UI is rendered).

In the embodiments, the user must also reason about two domains. The first domain is the local console, which invokes the circuit generation and logs error and normal messages. The second domain is where the circuit actually is generated and embedded for the application runtime, whether in a web app or remote proof system. This design allows for the IDE to separate the responsibilities of the application between the two unique domains it operates in.

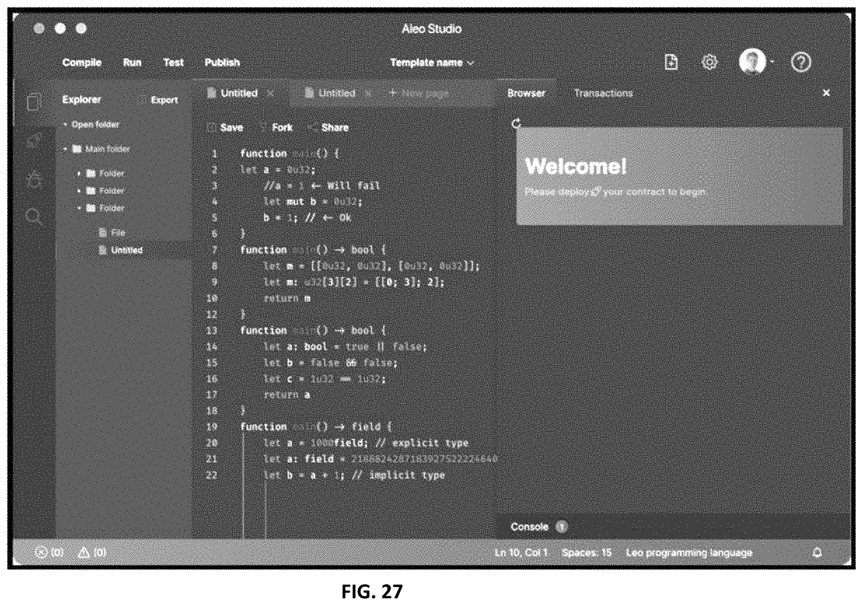

FIG. 27 illustrates exemplary UI rendering. Here, the normal UI rendering of the application with a Welcome page and action item that links the circuit to the UI, can be seen.

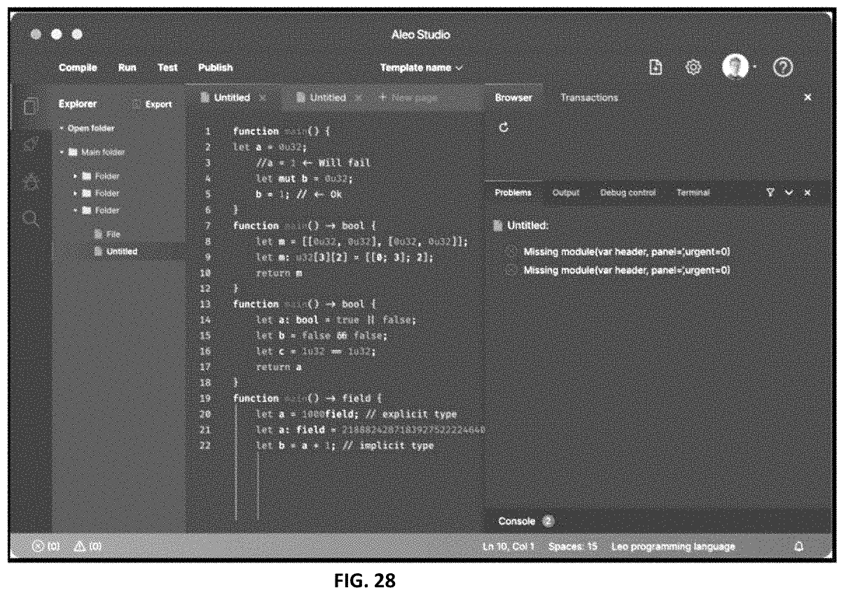

FIG. 28 illustrates exemplary console output responsive to zero-knowledge application. In FIG. 28, the console output shows the local console's response to running the zero-knowledge application.

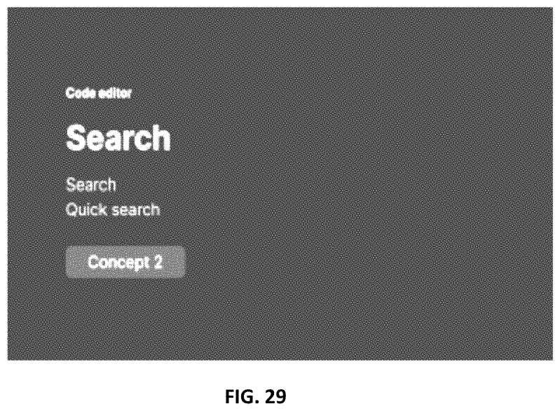

FIG. 29 illustrates an exemplary IDE search functionality. The search functionality allows the IDE to quickly parse circuits for tags and normal code options. Unlike traditional IDEs, circuits do not provide syntactic language that can be easily referenced. In this case, we employ a namespace function to allow the IDE to tag and annotate circuits with its own state, which the developer can then query to quickly find what it needs.

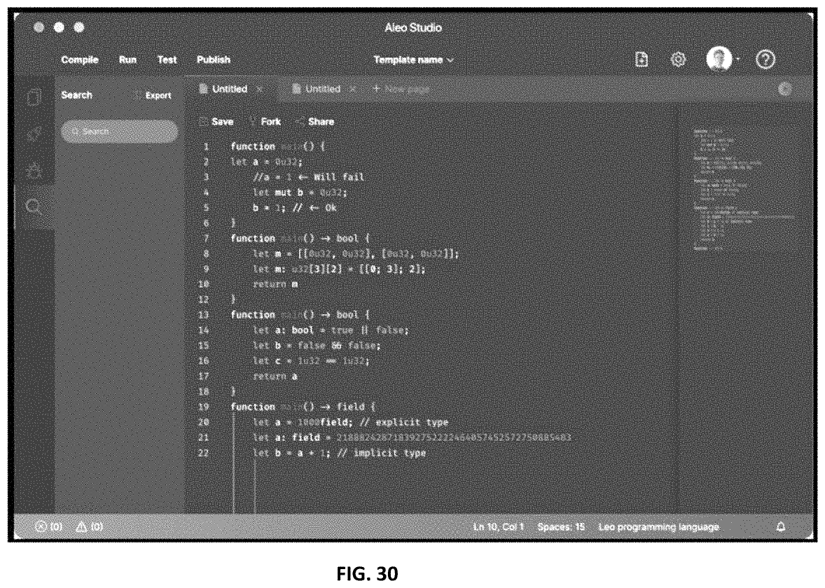

FIG. 30 illustrates an exemplary window of a normal search. In FIG. 30, the depiction indicates that the search looks and feels like a normal search. The goal here is to create an experience that normal developers are familiar with. Instead, we abstract the hard work under the hood by tagging every circuit with its function name, with its allocated assignment variable name, and with its fixed constant values or comments. These are then able to be parsed by the IDE when the developer types in the search box.

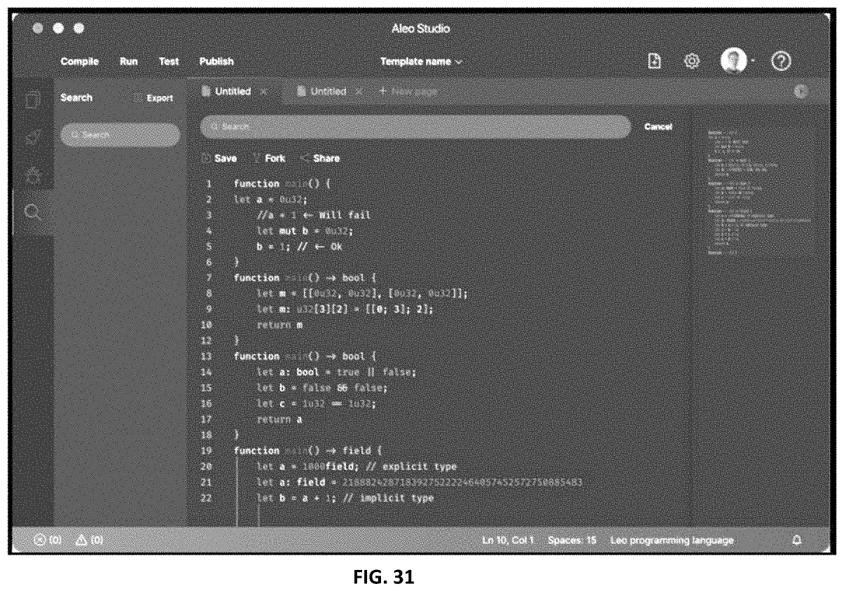

FIG. 31 illustrates an exemplary remote search function. In FIG. 31, the IDE is allowed to search locally. It is also allowed, however, to search remotely to the package manager for remote functions that are not available locally. This provides the developer with more options for what to import or use for their application.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A method providing tools in an integrated development environment (IDE) for performing one or more of defining, compiling, packaging, collaborating, and testing zero-knowledge proofs.
